(19) United States
(12) Patent Application Publication
(10) Pub. No.: US 2025/0229502 A1
(43) Pub. Date: Jul. 17, 2025

(54) APPARATUS FOR VULCANISING A TYRE, AND METHOD FOR OPERATING AN APPARATUS FOR VULCANISING TYRES

(71) Applicant: Continental Reifen Deutschland GmbH, Hannover (DE)

(72) Inventors: Karsten Wenzel, Helpsen (DE); Horst Wedekind, Garbsen (DE); Michael Ramm, Garbsen (DE); Ralph Harisch, Bad Emstal (DE)

(73) Assignee: Continental Reifen Deutschland GmbH, Hannover (DE)

(21) Appl. No.: 18/700,451

(22) PCT Filed: Oct. 7, 2022
(86) PCT No.: PCT/DE2022/200232

§ 371 Date: Apr. 11, 2024

(30) Foreign Application Priority Data
Oct. 11, 2021 (DE) 10 2021 211 452.0

(51) Int. Cl. B29D 30/06

(52) U.S. Cl. CPC B29D 30/0662; B29D 30/0629; B29D 2030/0667

(57) ABSTRACT

The invention relates to an apparatus (10) for vulcanizing a tire, with a tire receiving unit (12a), which has a vulcanizing mold (30a), wherein the vulcanizing mold (30a) provides a shaping and vulcanizing space for receiving a green tire (R1) to be vulcanized, with a fluid path (42) for a temperature control medium extending through an annular heating body (24a) of the tire receiving unit (12a), an insulating body (14), running around the tire receiving unit (12a), to reduce an exchange of heat between the tire receiving unit (12a) and the surroundings of the apparatus (10); and at least one pressure body (16), which is movable in the vertical direction and is arranged on an end face of the tire receiving unit (12a), a vertical movement of the pressure body (16) being able to initiate a horizontal movement of mold segments (28a) of the vulcanizing mold (30a) up to a green tire (R1) located in the vulcanizing space.

### CROSS-REFERENCE TO RELATED APPLICATIONS

The present application is a National Stage Application under 35 U.S.C. § 371 of International Patent Application No. PCT/DE2022/200232 filed on Oct. 7, 2022, the disclosures of which are herein incorporated by reference in their entireties.

### BRIEF SUMMARY

The invention relates to an apparatus for vulcanizing a tire, with a tire receiving unit, which has a vulcanizing mold, wherein the vulcanizing mold provides a shaping and vulcanizing space for receiving a green tire to be vulcanized, with a fluid path for a temperature control medium extending through an annular heating body of the tire receiving unit. The apparatus further comprises an insulating body, running around the tire receiving unit, to reduce an exchange of heat between the tire receiving unit and the surroundings of the apparatus. In addition, the apparatus comprises at least one pressure body, which is movable in the vertical direction and is arranged on an end face of the tire receiving unit, a vertical movement of the pressure body being able to initiate a horizontal movement of mold segments of the vulcanizing mold up to a green tire located in the vulcanizing space.

In addition, the invention relates to a system for vulcanizing tires of different shape and/or size.

The invention further relates to a method for operating an apparatus for vulcanizing tires, comprising the steps of: vulcanizing a first tire using a first tire receiving unit of the apparatus, wherein the first tire receiving unit has a first vulcanizing mold and the first vulcanizing mold provides a shaping and vulcanizing space for receiving a first green tire to be vulcanized, and separating one or more coupling connections of the first tire receiving unit, which are connected to a fluid path extending through an annular heating body of the first tire receiving unit, from one or more coupling connections, which are positioned in a connection zone of a vertically movable pressure body, of the vertically movable pressure body.

Apparatuses for vulcanizing tires, what are referred to as tire heating presses or tire vulcanizing machines, are intended ideally to be used for vulcanizing tires of different shape and/or size. For this purpose, the apparatuses may conventionally be equipped with different tire receiving units, what are referred to as containers.

The tire receiving units generally have one or more heating bodies, which are equipped with fluid paths, wherein a temperature control medium, for example hot steam, can be introduced into the respective fluid path for heating the heating body. The connections for introducing and discharging the temperature control medium of tire receiving units, which are used for vulcanizing tires of different shape and/or size, are arranged at different positions depending on the size of the tire receiving unit and/or are at different distances from one another. Therefore, an insulating body, running around the tire receiving unit, of the apparatus necessarily has one or more comparatively large recesses and/or openings so that the connections of the different tire receiving units can be received and are accessible. Through the recesses and openings of the insulating body, running around the tire receiving unit, a considerable amount of energy is released to the environment during operation of the apparatus due to convective heat transport. The apparatuses are also often designed to increase the heat loss additionally by means of a chimney effect.

The object on which the invention is based is thus to reduce the heat loss during the vulcanization of a tire, wherein the apparatus used is intended preferably to allow the vulcanization of tires of different shape and/or size.

The object is achieved by an apparatus of the type mentioned at the beginning, wherein the fluid path extending through the annular heating body of the tire receiving unit of the apparatus according to the invention runs outside the annular heating body, through the vertically movable pressure body.

Owing to the fact that the fluid path extending through the annular heating body of the tire receiving unit runs through the movable pressure body arranged on the end face, the fluid path is led out of the apparatus on the end face, i.e. on the top side or on the bottom side. Recesses and openings in the surrounding insulating body can be dispensed with, and therefore a convective heat loss is prevented or at least significantly reduced by heat exchange with the environment.

For example, the temperature control medium used may be steam. The steam condenses within the fluid path. The steam which is introduced is discharged from the apparatus as condensate. When steam is used as the temperature control medium, significant energy savings are achieved compared to an apparatus with a surrounding insulating body having recesses and/or openings, wherein said energy savings can be attributed to the suppression of the convective heat loss to the environment.

The mold segments of the vulcanizing mold are moved horizontally up to the green tire to vulcanize a green tire located in the vulcanizing space. The vertically movable pressure body of the apparatus may be, for example, a pressure plate.

The tire receiving unit can form the “container” of the apparatus. The apparatus can be a tire heating press or a tire vulcanizing machine.

In a particularly preferred embodiment of the apparatus according to the invention, the surrounding insulating body is free from notches. Preferably, the surrounding insulating body is an insulation cylinder without material recesses for the passage of fluid lines or fluid paths. Preferably, the surrounding insulating body is formed without any recesses and/or free from openings in the surrounding circumferential surface.

An apparatus according to the invention is furthermore preferred, in which the fluid path extending through the annular heating body of the tire receiving unit is connected to one or more media connections, wherein the one media connection or the plurality of media connections is or are arranged on that side of the vertically movable pressure body which faces away from the tire receiving unit. By means of the media connections, the fluid path is connectable to a media supply line and/or a media discharge line. Hot steam can be supplied to the fluid path via the media supply line. Condensate can be discharged from the fluid path via the media discharge line. The media connections may comprise a media inflow connection and/or a media outflow connection. The one media connection or the plurality of media connections for the fluid path extending through the annular heating body is or are preferably located on the end-side top side of the apparatus.

In a development, the apparatus according to the invention has an upper flat heating body, which is arranged above the shaping and vulcanizing space of the tire receiving unit, and through which a fluid path for a temperature control medium extends, wherein the fluid path extending through the upper flat heating body runs outside the upper flat heating body through the vertically movable pressure body. The fluid path extending through the flat upper heating body is preferably connected to one media connection or a plurality of media connections, wherein the one media connection or the plurality of media connections is or are arranged on that side of the vertically movable pressure body which faces away from the tire receiving unit. The upper flat heating body is preferably in the form of a heating plate into which the temperature control medium can be introduced. The fluid path extending through the upper flat heating body and the fluid path, which extends through the annular heating body, of the tire receiving unit preferably run through the vertically movable pressure body of the apparatus.

In a development of the apparatus according to the invention, the fluid path extending through the annular heating body of the tire receiving unit runs outside the annular heating body through the upper flat heating body. The passage point at which the fluid path extending through the annular heating body runs through the upper flat heating body is preferably arranged spaced apart from the fluid path of the upper flat heating body.

In a further preferred embodiment, the apparatus according to the invention has a lower flat heating body, which is arranged below the shaping and vulcanizing space of the tire receiving unit, and through which a fluid path for a temperature control medium extends, wherein the fluid path extending through the lower flat heating body runs outside the lower flat heating body through a fixed pressure body below the tire receiving unit. The fluid path extending through the flat lower heating body is preferably connected to one media connection or a plurality of media connections, wherein the one media connection or the plurality of media connections is or are arranged on that side of the fixed pressure body which faces away from the tire receiving unit. The lower flat heating body is preferably a heating plate.

In addition, an apparatus according to the invention is preferred, in which the annular heating body is in the form of a closing ring which is conical in some sections and which is designed, via a vertical movement, to horizontally move one or more mold support parts supporting the vulcanizing mold. The closing ring and the mold support parts may be made from steel. The vulcanizing mold or the mold segments of the vulcanizing mold may be made from aluminum. The closing ring may have a cone. The one mold support part or the plurality of mold support parts may have a mating cone which, during a vertical movement of the annular heating body in the form of a closing ring, is in contact with the cone of the annular heating body.

An apparatus according to the invention is furthermore advantageous, in which the fluid path extending through the annular heating body of the tire receiving unit is connected to one coupling connection or a plurality of coupling connections of the tire receiving unit, wherein the one coupling connection or the plurality of coupling connections of the tire receiving unit is or are connected in a connection zone of the vertically movable pressure body, in particular so as to be releasable without being destroyed, to coupling connections of the vertically movable pressure body. The tire receiving unit can preferably be removed from the apparatus. The apparatus can be equipped with different tire receiving units, and therefore, by means of the apparatus, tires of different shape and/or size can be vulcanized using different tire receiving units. After the insertion of the tire receiving unit into the apparatus, the one coupling connection or the plurality of coupling connections of the tire receiving unit are thus already positioned in such a way that they can be brought into the connection zone of the pressure body by a vertical movement of the pressure body. The connection of the coupling connections between the tire receiving unit and the pressure body can thus be realized with comparatively little effort.

In a particularly preferred embodiment of the apparatus according to the invention, the connection zone is in the form of a universal interface for connecting coupling connections of different tire receiving units. The different tire receiving units, which can be inserted into the apparatus, thus have coupling connections, which are compatible with the connection zone of the vertically movable pressure body, and therefore a universal interface for the connection of coupling connections of different tire receiving units is produced.

### DETAILED DESCRIPTION

The object on which the invention is based is further achieved by a system of the type mentioned at the beginning, wherein the system according to the invention comprises an apparatus according to one of the embodiments described above. The system further comprises an alternative tire receiving unit, which has a vulcanizing mold, wherein the vulcanizing mold provides a shaping and vulcanizing space for receiving a green tire to be vulcanized, wherein a fluid path for a temperature control medium extends through an annular heating body of the tire receiving unit, and the fluid path extending through the annular heating body of the alternative tire receiving unit is connected outside the annular heating body to one or more coupling connections of the alternative tire receiving unit. The tire receiving unit of the apparatus is replaceable by the alternative tire receiving unit for operating the apparatus with the alternative tire receiving unit. The one coupling connection or the plurality of coupling connections of the alternative tire receiving unit, after removal of the tire receiving unit, is or are connectable, in particular so as to be releasable without being destroyed, in a connection zone of the vertically movable pressure body, to coupling connections of the vertically movable pressure body.

The object on which the invention is based is further achieved by a method of the type mentioned at the beginning, wherein, within the scope of the method according to the invention, the first tire receiving unit is replaced with a second tire receiving unit, wherein the second tire receiving unit has a second vulcanizing mold, and the second vulcanizing mold provides a shaping and vulcanizing space for receiving a second green tire to be vulcanized. After replacing the first tire receiving unit with the second tire receiving unit, one coupling connection or a plurality of coupling connections of the second tire receiving unit, which are connected to a fluid path extending through an annular heating body of the second tire receiving unit, are connected to the one coupling connection or the plurality of coupling connections, which are positioned in the connection zone of the vertically movable pressure body, of the vertically movable pressure body. A second tire is then vulcanized using the second tire receiving unit.

Within the scope of the method according to the invention, two different tire receiving units are thus used for vulcanizing tires which differ in their shape and/or size from one another. However, the one coupling connection or the plurality of coupling connections of the first and second tire receiving units are arranged at the same position and/or have the same geometry, and therefore the connection zone can be used as a universal interface for connecting the coupling connections of the first and the second tire receiving units.

Preferred embodiments of the invention are explained and described in more detail below with reference to the accompanying drawings. In the drawings:

FIG. 1 shows an apparatus according to the invention for vulcanizing a tire with an open first tire receiving unit, in a schematic sectional illustration;

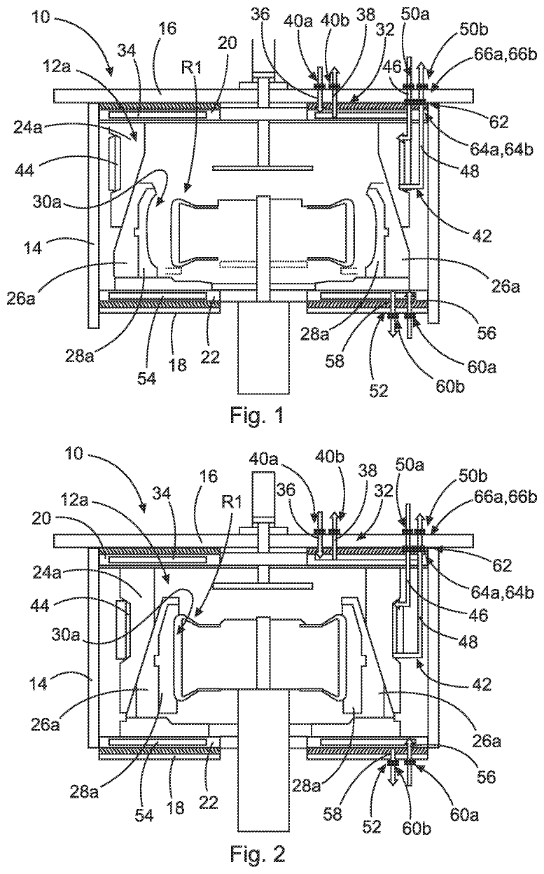

FIG. 2 shows the apparatus reproduced in FIG. 1 after closing the first tire receiving unit, in a schematic sectional illustration; and

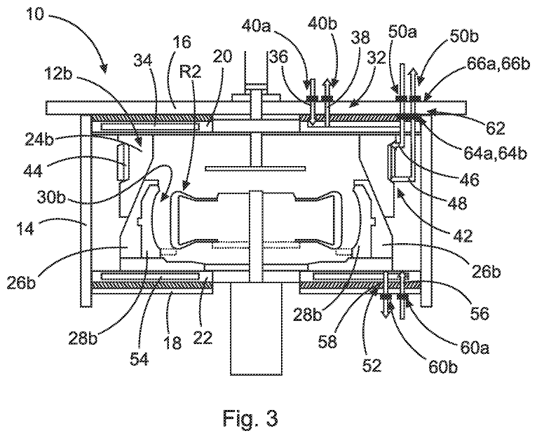

FIG. 3 shows the apparatus reproduced in FIG. 1 with an open second tire receiving unit, in a schematic sectional illustration.

FIG. 1 shows an apparatus 10 for vulcanizing a tire. The apparatus 10 may also be referred to as a heating press or tire vulcanizing machine. The apparatus 10 can be equipped for vulcanizing tires of different shape and/or size with different tire receiving units 12a, 12b, wherein the tire receiving units 12a, 12b may also be referred to as containers.

The apparatus 10 has an insulating body 14, which runs around the tire receiving unit 12a and is formed from a heat-resistant insulating material. The insulating body 14 has a cylindrical basic shape and is designed to reduce the heat exchange between the tire receiving unit 12a and the environment of the apparatus 10. The insulating body 14 has no recesses or openings and is free from notches, and therefore a possible exchange of fluid and/or heat via recesses, openings or notches is avoided.

A vertically movable pressure body 16, which is in the form of a pressure plate, is located above the tire receiving unit 12a. A fixed pressure body 18, which is also in the form of a pressure plate, is located below the tire receiving unit 12a.

The apparatus 10 further comprises an upper flat heating body 20, a lower flat heating body 22 and an annular heating body 24a. The annular heating body 24a is part of the tire receiving unit 12a. The upper flat heating body 20a is arranged below the vertically movable pressure body 16. The lower flat heating body 22 is arranged above the fixed pressure body 18. The annular heating body 24a is a closing ring which is conical in some sections and which is designed also to be moved in a vertical direction during a vertical movement of the pressure body 16. Via the vertical movement of the conical heating body 24a, mold support parts 26a of the tire receiving unit 12a are moved horizontally. The mold support parts 26a have a mating cone to the cone of the annular heating body 24a, which is in the form of a closing ring. Mold segments 28a, which form a vulcanizing mold 30a, are fixed on the mold support parts 26a. The vulcanizing mold 30a also includes an upper and a lower side shell and an upper and lower bead ring, which are not reproduced for illustrative reasons. The vulcanizing mold 30a provides a shaping and vulcanizing space for receiving a green tire R1 to be vulcanized. For closing the vulcanizing mold 30a, the mold segments 28a of the vulcanizing mold 30a are moved in the horizontal direction via the vertically movable pressure body 16, the annular heating body 24a and the mold support parts 26a up to the green tire R1 located in the vulcanizing space. Vulcanization of the green tire R1 is then carried out with the vulcanizing mold 30a closed.

Fluid paths 32, 42, 52 are provided for heating the heating bodies 20, 22, 24a. Via the fluid paths 32, 42, 52, a temperature control medium, for example hot steam, can be introduced into the heating bodies 20, 22, 24a.

The fluid path 32 extends through the upper flat heating body 20 and comprises a media supply line 36, a fluid chamber 34 and a media discharge line 38. Hot steam can be introduced into the fluid chamber 34 within the upper flat heating body 20 via the media supply line 36. Condensate can be discharged from the fluid chamber 34 in the upper flat heating body 20 via the media discharge line 38. The media supply line 36 and the media discharge line 38 of the fluid path 32 extend through the vertically movable pressure body 16 and are connected to media connections 40a, 40b, wherein the media connections 40a, 40b are arranged on that side of the vertically movable pressure body 16 which faces away from the tire receiving unit 12a.

The fluid path 42 extends through the annular heating body 24a of the tire receiving unit 12a and comprises a media supply line 46, a fluid chamber 44 and a media discharge line 48. The fluid chamber 44 is arranged within the annular heating body 24a. Via the media supply line 46, hot steam can be introduced into the fluid chamber 44, wherein the condensate forming in the fluid chamber 44 can be discharged from the fluid chamber 44 via the media discharge line 48. The media supply line 46 and the media discharge line 48 of the fluid path extending through the annular heating body 24 run through the upper flat heating body 20 and through the vertically movable pressure body 16. The fluid path 42 extending through the annular heating body 24a of the tire receiving unit 12a is connected to media connections 50a, 50b, wherein the media connections 50a, 50b are arranged on that side of the vertically movable pressure body 16 which faces away from the tire receiving unit 12a.

The fluid path 52 extends through the lower flat heating body 22 and comprises a media supply line 56, a fluid chamber 54 and a media discharge line 58. Hot steam can be introduced into the fluid chamber 54 within the lower flat heating body 22 via the media supply line 56. Condensate can be discharged from the fluid chamber 54 in the lower flat heating body 20 via the media discharge line 58. The media supply line 56 and the media discharge line 58 of the fluid path 52 extend through the fixed pressure body 18 and are connected to media connections 60a, 60b, wherein the media connections 60a, 60b are arranged on that side of the fixed pressure body 18 which faces away from the tire receiving unit 12a.

The fluid path 42 extending through the annular heating body 24a of the tire receiving unit 12a is connected with coupling connections 64a, 64b of the tire receiving unit 12a in a connection zone 62 of the vertically movable pressure body 16 to coupling connections 66a, 66b of the vertically movable pressure body 16. The connection zone 62 is in the form of a universal interface for connecting coupling connections 64a, 64b of different tire receiving units 12a, 12b.

FIG. 2 shows an apparatus 10 with a closed tire receiving unit 12a. The mold segments 28a of the vulcanizing mold 30a have thus been moved horizontally by a vertical movement of the pressure body 16 up to the green tire R1 located in the vulcanizing space. In the state shown, the green tire R1 is then vulcanized.

FIG. 3 shows that the apparatus 10 can be equipped with an alternative tire receiving unit 12b. For this purpose, the tire receiving unit 12a has to be removed from the apparatus 10 so that the tire receiving unit 12b can be installed in the apparatus 10. The tire receiving unit 12b can be used to vulcanize tires with a different shape and/or size. For this purpose, the tire receiving unit 12 has a vulcanizing mold 30b, wherein the vulcanizing mold 30b provides a shaping and vulcanizing space for receiving a green tire R2 to be vulcanized. A fluid path 42 for a temperature control medium also extends through the annular heating body 24b of the tire receiving unit 12b, wherein the fluid path 42 extending through the annular heating body 24b is connected outside the annular heating body 24b to coupling connections 64a, 64b of the tire receiving unit 12b. The coupling connections 64a, 64b of the tire receiving unit 12b are connected in the connection zone 62 of the vertically movable pressure body 16 to the coupling connections 66a, 66b of the vertically movable pressure body 16.

Despite the fact that the annular heating body 24b, the mold support parts 26b and the mold segments 28b of the tire receiving unit 12b differ in respect of their geometry from the corresponding parts of the tire receiving unit 12a, the tire receiving units 12a, 12b can be used in the same apparatus 10. The connection zone 62, which is in the form of a universal interface for the connection of coupling connections 64a, 64b of different tire receiving units 12a, 12b, permits a quick and effortless change of the tire receiving units 12a, 12b for vulcanizing tires of different shape and/or size.

1-11. (canceled)

12. An apparatus for vulcanizing a tire, the apparatus comprising:
a tire receiving unit, which has a vulcanizing mold, wherein the vulcanizing mold provides a shaping and vulcanizing space for receiving a green tire to be vulcanized, with a fluid path for a temperature control medium extending through an annular heating body of the tire receiving unit;
an insulating body, running around the tire receiving unit, to reduce an exchange of heat between the tire receiving unit and surroundings of the apparatus;
a pressure body, which is movable in the vertical direction and is arranged on an end face of the tire receiving unit, a vertical movement of the pressure body being able to initiate a horizontal movement of mold segments up to the green tire, located in a vulcanizing space; and
wherein the fluid path extends through the annular heating body and runs outside the annular heating body, through a vertically movable pressure body of the annular heating body.

13. The apparatus of claim 12, wherein the surrounding insulating body is free from notches.

14. The apparatus of claim 12, wherein the fluid path extending through the annular heating body of the tire receiving unit is connected to one media connection or plurality of media connections, wherein the one media connection or the plurality of media connections is or are arranged on that side of the vertically movable pressure body which faces away from the tire receiving unit.

15. The apparatus of claim 12, wherein an upper flat heating body, which is arranged above the shaping and vulcanizing space of the tire receiving unit, and through which a fluid path for a temperature control medium extends, wherein the fluid path extending through the upper flat heating body runs outside the upper flat heating body through the vertically movable pressure body.

16. The apparatus of claim 15, wherein the fluid path extending through the annular heating body of the tire receiving unit runs outside the annular heating body through the upper flat heating body.

17. The apparatus of claim 12, wherein a lower flat heating body, which is arranged below the shaping and vulcanizing space of the tire receiving unit, and through which a fluid path for a temperature control medium extends, wherein the fluid path extending through the lower flat heating body runs outside the lower flat heating body through a fixed pressure body below the tire receiving unit.

18. The apparatus of claim 12, wherein the annular heating body is in the form of a closing ring which is conical in some sections and which is designed, via a vertical movement, to horizontally move one or more mold support parts supporting the vulcanizing mold.

19. The apparatus of claim 12, wherein the fluid path extending through the annular heating body of the tire receiving unit is connected to one coupling connection or a plurality of coupling connections of the tire receiving unit, wherein the one coupling connection or the plurality of coupling connections of the tire receiving unit is or are connected in a connection zone of the vertically movable pressure body, in particular so as to be releasable without being destroyed, to coupling connections of the vertically movable pressure body.

20. The apparatus of claim 19, wherein the connection zone is in the form of a universal interface for connecting coupling connections of different tire receiving units.

21. A system for vulcanizing tires of different shape and/or size, the system comprising:
an apparatus comprising:
a tire receiving unit, which has a vulcanizing mold, wherein the vulcanizing mold provides a shaping and vulcanizing space for receiving a green tire to be vulcanized, with a fluid path for a temperature control medium extending through an annular heating body of the tire receiving unit;
an insulating body, running around the tire receiving unit, to reduce an exchange of heat between the tire receiving unit and surroundings of the apparatus;
a pressure body, which is movable in the vertical direction and is arranged on an end face of the tire receiving unit, a vertical movement of the pressure body being able to initiate a horizontal movement of mold segments up to the green tire, located in a vulcanizing space; and
wherein the fluid path extends through the annular heating body and runs outside the annular heating body, through a vertically movable pressure body of the annular heating body;
an alternative tire receiving unit, which has a vulcanizing mold, wherein the vulcanizing mold provides a shaping and vulcanizing space for receiving a green tire to be vulcanized, wherein a fluid path for a temperature control medium extends through an annular heating body of the alternative tire receiving unit, and the fluid path extending through the annular heating body of the alternative tire receiving unit is connected outside the annular heating body to one or more coupling connections of the alternative tire receiving unit;
wherein the tire receiving unit is replaceable by the alternative tire receiving unit for operating the apparatus with the alternative tire receiving unit, and the one coupling connection or the plurality of coupling connections of the alternative tire receiving unit, after removal of the tire receiving unit, are connectable, in particular so as to be releasable without being destroyed, in the connection zone of the vertically movable pressure body, to coupling connections of the vertically movable pressure body.

22. A method for operating an apparatus for vulcanizing tires, comprising:
vulcanizing a first tire using a first tire receiving unit, wherein the first tire receiving unit has a first vulcanizing mold and the first vulcanizing mold provides a shaping and vulcanizing space for receiving a first green tire to be vulcanized, and
separating one or more coupling connections of the first tire receiving unit, which are connected to a fluid path extending through an annular heating body of the first tire receiving unit, from one or more coupling connections, which are positioned in a connection zone of a vertically movable pressure body, of the vertically movable pressure body;
replacing the first tire receiving unit with a second tire receiving unit, wherein the second tire receiving unit has a second vulcanizing mold, and the second vulcanizing mold provides a shaping and vulcanizing space for receiving a second green tire to be vulcanized,
connecting one or more coupling connections of the second tire receiving unit, which are connected to a fluid path extending through an annular heating body of the second tire receiving unit, to the one coupling connection or the plurality of coupling connections, which are positioned in the connection zone of the vertically movable pressure body, of the vertically movable pressure body; and
vulcanizing the second tire using the second tire receiving unit.
